(19) United States
(12) Patent Application Publication
(10) Pub. No.: US 2010/0261632 A1
(43) Pub. Date: Oct. 14, 2010

(54) NON-FLUORIDE CONTAINING COMPOSITION FOR THE REMOVAL OF RESIDUE FROM A MICROELECTRONIC DEVICE

(75) Inventors: Michael Korzenski, Danbury, CT (US); Ping Jiang, Danbury, CT (US); Brittany Serke, Rochester, NY (US)

Correspondence Address: MOORE & VAN ALLEN PLLC, P.O. BOX 13706, Research Triangle Park, NC, 27709, US

(73) Assignee: ADVANCED TECHNOLOGY MATERIALS, INC., Danbury, CT (US)

(21) Appl. No.: 12/671,324

(22) PCT Filed: Aug. 4, 2008
(86) PCT No.: PCT/US08/72048

§ 371 Date: Jun. 3, 2010

Related U.S. Application Data
(60) Provisional application No. 60/953,605, filed on Aug. 2, 2007.

(51) Int. Cl. C11D 7/34; C11D 7/36

(52) U.S. Cl. 510/175

(57) ABSTRACT

Cleaning compositions and processes for removing residue from a microelectronic device having said residue thereon. The composition, which is substantially devoid of fluoride species, amine species, and organic solvents, achieves highly efficacious cleaning of the residue material, including post-etch residue, post-ash residue and/or post-CMP residue, from the microelectronic device while simultaneously not damaging the interlevel dielectric and metal interconnect material also present thereon.

### FIELD

The present invention relates generally to residue removal compositions that are substantially devoid of fluoride species and that are useful for the removal of residue from a microelectronic device having same thereon.

### DESCRIPTION OF THE RELATED ART

The demand in the microelectronic device industry for compatible and environmentally friendly wafer cleaning compositions for the removal of residue from a device having said residue thereon is substantial. For example, novel cleaning solutions are needed to remove residue generated as a result of plasma etching of various types of metals and silicon-containing materials such as, but not limited to, aluminum, aluminum/silicon/copper, titanium, titanium nitride, titanium/tungsten, tungsten, silicon oxide and polysilicon crystal.

Presently, hydroxylamine-containing (HDA) compositions make-up the vast majority of the commercial back end of the line (BEOL) cleaning products. That said, because hydroxylamine-based chemistries perform best at temperatures in the 60° C.-70° C. range, the total deionized water content of an aqueous solution containing same can decrease by as much as 50% over a 20-hour period, which severely limits the bath-life of the composition.

Moreover, traditional amine-based chemistries operate by dissolving residues, e.g., post-etch residue, and an organic film of nitrogen or corrosion inhibitor species may remain on the cleaned device surfaces prior to rinsing. Aqueous rinses diffuse through this organic film and the combination of amines and water can generate hydroxide species that can shift the pH on metal surfaces to greater than 11. Aluminum and copper can corrode in the presence of such high pH values and the amine species. Importantly, this corrosion mechanism does not occur with semi-aqueous cleaning chemistries because these formulations do not contain amines in sufficient quantities to form additional corrosive hydroxide species in the aqueous rinse and as such, do not experience an increase in pH above their initial value.

An example of a semi-aqueous cleaning chemistry includes the IDEAL clean, which is composed of organic solvents, water, low concentrations of fluoride and other active species, and buffering agents to control chemical activity, with a pH range of 6-8. Advantageously, most commercially available semi-aqueous products, as well as IDEAL clean, can be used at near-ambient temperatures (23° C.-30° C.) with process times varying between 2 and 30 minutes. In addition, they can be rinsed directly in water, reducing water-rinse volumes. That said, one disadvantage of IDEAL clean is that it is not compatible with quartz over long exposure periods due to the existence of fluoride ions in the cleaner. Accordingly, many fabs that have tool sets that include either quartz baths or quartz heaters cannot utilize IDEAL clean without modifying or changing tool sets.

Towards that end, a novel composition is needed that is compatible with current tool sets and effectively and efficiently removes residue and/or contaminants from the surface of a microelectronic device. Compositions that are substantially devoid of fluorides and amines are preferred because of the compatibility with quartz, the longer bath life, the lower processing temperatures and the higher throughput relative to compositions currently in the art.

### SUMMARY

The present invention generally relates to a composition for the removal of residue material from a microelectronic device having said residue thereon, and a method of using said composition. Preferably, the composition is substantially devoid of amine species, fluoride species and organic solvent yet efficaciously removes post-etch, post-ash, and/or post-CMP residue from the surface of the microelectronic device without damaging any of the underlying materials such as low-k dielectrics and metal-containing layers.

In one aspect, a removal composition including at least one complexing agent, wherein the composition is useful for removing residue material(s) from a microelectronic device having same thereon is described. Preferably, the at least one complexing agent comprises a compound selected from the group consisting of aminocarboxylic acids, organic acids and derivatives thereof, phosphonic acids and derivatives thereof, and combinations thereof.

In another aspect, a removal composition comprising, consisting essentially of, or consisting of at least one complexing agent and at least one surfactant is described, wherein the composition is useful for removing residue material(s) from a microelectronic device having same thereon. Preferably, the at least one complexing agent comprises a compound selected from the group consisting of aminocarboxylic acids, organic acids and derivatives thereof, phosphonic acids and derivatives thereof, and combinations thereof, and preferably the at least one surfactant comprises a phosphate ester.

In still another aspect, a removal composition comprising, consisting essentially of, or consisting of a salicylic acid derivative and a phosphonic acid derivative is described, wherein said composition is useful for the removal of residue from a microelectronic device having same thereon.

Yet another aspect relates to a removal composition consisting essentially of or consisting of a salicylic acid derivative, a phosphonic acid derivative, and water, wherein said composition is useful for the removal of residue from a microelectronic device having same thereon.

Still another aspect relates to a kit comprising, in one or more containers, one or more of the following reagents for forming a removal composition, said one or more reagents selected from the group consisting of at least complexing agent, optionally at least one surfactant, optionally at least one corrosion inhibitor, optionally at least one buffering agent, and optionally at least one anti-oxidant, and wherein the kit is adapted to form a removal composition suitable for removing residue from a microelectronic device having said residue thereon.

Another aspect relates to a method of removing residue from a microelectronic device having said residue thereon, said method comprising contacting the microelectronic device with an aqueous removal composition for sufficient time to at least partially remove said residue from the microelectronic device, wherein the removal composition includes at least complexing agent, optionally at least one surfactant, optionally at least one corrosion inhibitor, optionally at least one buffering agent, and optionally at least one anti-oxidant.

In a further aspect, relates to a method of manufacturing a microelectronic device, said method comprising contacting the microelectronic device with a composition described herein for sufficient time to at least partially remove residue and/or contaminants from the microelectronic device having said residue and/or contaminants thereon.

Yet another aspect relates to improved microelectronic devices, and products incorporating same, made using the methods described herein, said method comprising removing residue and/or contaminants from the microelectronic device having said residue and/or contaminants thereon, using the methods and/or compositions described herein, and optionally, incorporating the microelectronic device into a product.

Another aspect relates to an article of manufacture comprising a composition, a microelectronic device wafer, and residue and/or contaminants, wherein the composition comprises at least complexing agent, optionally at least one surfactant, optionally at least one corrosion inhibitor, optionally at least one buffering agent, and optionally at least one anti-oxidant.

Other aspects, features and advantages will be more fully apparent from the ensuing disclosure and appended claims.

### DETAILED DESCRIPTION AND PREFERRED EMBODIMENTS THEREOF

The present invention relates generally to compositions and methods for the removal of residue from the surface of a microelectronic device having same thereon. Preferably, the compositions are substantially devoid of fluoride and amines, are useful for the removal of residue and/or contaminants from the surface of a device, and are compatible with currently used tool sets. Advantageously, the compositions described herein are compatible with low-k dielectric and metal-containing materials on the microelectronic device.

For ease of reference, “microelectronic device” corresponds to semiconductor substrates, flat panel displays, phase change memory devices, solar panels and photovoltaics, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly.

As used herein, “residue” corresponds to particles generated during the manufacture of a microelectronic device including, but not limited to, plasma etching, ashing, chemical mechanical polishing, wet etching, and combinations thereof.

As used herein, “contaminants” correspond to chemicals, excluding residue, present on the surface of the microelectronic device subsequent to the plasma etching, ashing, wet etching, or chemical mechanical polishing process, reaction and chemical by-products, and any other materials that are the by-products of said processes. Typically, contaminants will be organic in nature.

As used herein, “post-CMP residue” corresponds to particles from the polishing slurry, e.g., silica-containing particles, chemicals present in the slurry, reaction by-products of the polishing slurry, carbon-rich particles, polishing pad particles, brush deloading particles, equipment materials of construction particles, copper, copper oxides, copper-containing materials, aluminum, aluminum oxides, aluminum-containing materials, organic residues, and any other materials that are the by-products of the CMP process.

As defined herein, “low-k dielectric material” corresponds to any material used as a dielectric material in a layered microelectronic device, wherein the material has a dielectric constant less than about 3.5. Preferably, the low-k dielectric materials include low-polarity materials such as silicon-containing organic polymers, silicon-containing hybrid organic/inorganic materials, organosilicate glass (OSG), TEOS, fluorinated silicate glass (FSG), silicon dioxide, and carbon-doped oxide (CDO) glass. It is to be appreciated that the low-k dielectric materials may have varying densities and varying porosities.

As defined herein, “post-etch residue” corresponds to material remaining following gas-phase plasma etching processes, e.g., BEOL dual damascene processing. The post-etch residue may be organic, organometallic, organosilicic, or inorganic in nature, for example, silicon-containing material, carbon-based organic material, and etch gas residue such as oxygen and fluorine.

As defined herein, “post-ash residue,” as used herein, corresponds to material remaining following oxidative or reductive plasma ashing to remove hardened photoresist and/or bottom anti-reflective coating (BARC) materials. The post-ash residue may be organic, organometallic, organosilicic, or inorganic in nature.

“Substantially devoid” and “devoid” is defined herein as less than 2 wt. %, preferably less than 1 wt. %, more preferably less than 0.5 wt. %, and most preferably less than 0.1 wt. %.

As used herein, “about” is intended to correspond to ±5% of the stated value.

As used herein, “suitability” for removing residue from a microelectronic device having said residue thereon corresponds to at least partial removal of said residue from the microelectronic device. Preferably, between 50 and 85% of the residue are removed from the microelectronic device using the compositions described herein, more preferably at least 90%, even more preferably at least 95%, and most preferably at least 99% of the residue are removed.

As defined herein, “metals” correspond to: tantalum, tantalum nitride, titanium nitride, titanium, nickel, cobalt, tungsten, and silicides thereof; copper-containing layers; aluminum-containing layers; Al/Cu layers; alloys of Al; alloys of Cu; cobalt-containing layers such as CoWP and CoWBP; gold-containing layers; Au/Pt layers; hafnium oxides; hafnium oxysilicates; zirconium oxides; lanthanide oxides; titanates; nitrogen-doped analogues thereof; ruthenium; iridium; cadmium; lead; indium; selenium; silver; MoTa; and combinations and salts thereof on the microelectronic device.

As used herein, “fluoride” species correspond to species including an ionic fluoride (F⁻). It is to be appreciated that the fluoride species may be included as a fluoride species or generated in situ.

As defined herein, “complexing agent” includes those compounds that are understood by one skilled in the art to be complexing agents, chelating agents, sequestering agents, and combinations thereof. Complexing agents will chemically combine with or physically hold the metal atom and/or metal ion to be removed using the compositions described herein.

As defined herein, “amine” species include at least one primary, secondary, or tertiary amine, ammonia, and/or quaternary ammonium hydroxide compounds (e.g., ammonium hydroxide, alkylammonium hydroxide, alkylarylammonium hydroxide, etc.), with the proviso that species including both a carboxylic acid group and an amine group are not considered “amines” according to this definition. Alkylammonium hydroxide compounds have the general formula R₁R₂R₃R₄NOH where R₁, R₂, R₃ and R₄ are the same as or different from one another and are C₁-C₆ alkyl groups (e.g., methyl, ethyl, propyl, butyl, pentyl or hexyl). Alkylarylammonium hydroxide compounds have the general formula R₁R₂R₃R₄NOH where R₁, R₂, R₃ and R₄ are the same as or different from one another and are C₁-C₆ alkyl groups (e.g., methyl, ethyl, propyl, butyl, pentyl or hexyl) and substituted or unsubstituted C₆-C₁₀ aryl groups (e.g., benzyl).

Compositions may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

In general, the aqueous compositions include at least one complexing agent, wherein the composition is useful for the removal of residue and/or contaminants from the surface of a microelectronic device. The compositions are preferably substantially devoid of organic solvent, amine species, and/or fluoride species.

In one aspect, a composition comprising at least one complexing agent, optionally at least one corrosion inhibitor, optionally a pH buffering agent, optionally at least one anti-oxidant, and optionally at least one surfactant is described, wherein the composition is useful for the removal of residue from a microelectronic device having same thereon. In another aspect, a composition comprising at least one complexing agent, at least one surfactant, optionally at least one corrosion inhibitor, optionally a pH buffering agent, and optionally at least one anti-oxidant is described. In yet another aspect, a composition comprising at least one complexing agent, at least one surfactant, at least one corrosion inhibitor, optionally a pH buffering agent, and optionally at least one anti-oxidant is described. The compositions include water and are preferably substantially devoid of organic solvent, amine species, and/or fluoride species.

In the broad practice of this aspect, the compositions may comprise, consist of, or consist essentially of: (i) at least one complexing agent; (ii) at least one complexing agent and at least one surfactant; or (iii) at least one complexing agent, at least one surfactant, and at least one corrosion inhibitor, wherein the composition is substantially devoid of organic solvent, amine species, and/or fluoride species. It is to be understood that in each embodiment, water may be a component. Further, in each embodiment, unless already present, the compositions may include at least one corrosion inhibitor, a pH buffering agent, and at least one anti-oxidant. In general, the specific proportions and amounts of components, in relation to each other, may be suitably varied to provide the desired removal action of the composition for the residue and/or processing equipment, as readily determinable within the skill of the art without undue effort. The water is preferably deionized.

The complexing agents preferably have a high affinity for aluminum-containing residues typically found on metal lines and vias after plasma ashing. Chelating agents contemplated include, but are not limited to, aminocarboxylic acids, organic acids and derivatives thereof, phosphonic acids and derivatives thereof, and combinations thereof including: (ethylenedinitrilo)tetraacetic acid (EDTA), butylenediaminetetraacetic acid, (1,2-cyclohexylenedinitrilo)tetraacetic acid (CyDTA), diethylenetriaminepentaacetic acid (DTPA), ethylenediaminetetrapropionic acid, (hydroxyethyl)ethylenediaminetriacetic acid (HEDTA), N,N,N′,N′-ethylenediaminetetra(methylenephosphonic)acid (EDTMP), triethylenetetraminehexaacetic acid (TTHA), 1,3-diamino-2-hydroxypropane-N,N,N′,N′-tetraacetic acid (DHPTA), methyliminodiacetic acid, propylenediaminetetraacetic acid, 1,5,9-triazacyclododecane-N,N′,N″-tris(methylenephosphonic acid) (DOTRP), 1,4,7,10-tetraazacyclododecane-N,N′,N″,N″-tetrakis(methylenephosphonic acid) (DOTP), nitrilotris(methylene)triphosphonic acid, diethylenetriaminepenta(methylenephosphonic acid) (DETAP), aminotri(methylenephosphonic acid), 1-hydroxyethylidene-1,1-diphosphonic acid (HEDP), bis(hexamethylene)triamine phosphonic acid, 1,4,7-triazacyclononane-N,N′,N″-tris(methylenephosphonic acid (NOTP), 2-phosphonobutane-1,2,4-tricarboxylic acid, nitrilotriacetic acid (NTA), citric acid, tartaric acid, gluconic acid, saccharic acid, glyceric acid, oxalic acid, phthalic acid, maleic acid, mandelic acid, malonic acid, lactic acid, o-, m-, or p-salicylic acid and derivatives thereof, dihydroxybenzoic acid, 5-sulfosalicylic acid, dimethylsulfoxide (DMSO), catechol, gallic acid, propyl gallate, pyrogallol, 8-hydroxyquinoline, cysteine, and combinations thereof. Examples of complexing agents include, but are not limited to, phosphoric acid, nitric acid, sulfuric acid, hydrochloric acid, hydrofluoric acid, alkyldimethylbenzylammonium chloride, ammonium chloride, potassium chloride, ammonium fluoride, and combinations thereof.

Other metal chelators useful in aqueous systems for complexing aluminum ions include, but are not limited to, acetic acid, dihydroxysalicylic acid, iminodiacetic acid, glyphosphate, N-(Phosphonomethyl)-iminodiacetic acid, formic acid, propanoic acid, butanoic acid, sulfate ions, N-(2-Hydroxyethyl)-iminodiacetic acid, pyridine-2,5-dicarboxylic acid, pyridine-2,6-dicarboxylic acid, 7-Iodo-8-hydroxyquinoline-5-sulfonic acid, 2-amino-2-propylphosphonic acid, 1,2-dihydroxybenzene-4-sulfonic acid, 4,5-dihydroxy-1,3-benzene disulfonic acid (Tiron), solochrome violet R, 3-hydroxy-2-naphthoic acid, chromotropic acid, nitroacetic acid, oxydiacetic acid, thiodiacetic acid, 8-hydroxy-7-(arylazo)-quinoline-5-sulfonic acid, 2-oxobutanoic acid, acetoacetic acid, phenylserine, L-ascorbic acid, squaric acid, acetohydroxamic acid, 3-hydroxy-5,7-disulfo-2-naphthoic acid, 2,3-dihydroxynaphthalene-6-sulfonic acid, sulfoxine, oxine, succinic acid, 3,4-dihydroxybenzoic acid, 2-(3,4-dihydroxyphenyl)-2-(1,1-benzopyran)-3,5,7-triol, 3-hydroxy-7-sulfo-2-naphthoic acid, 1,2-dihydroxynaphthalene-4-sulfonic acid, N,N-bis(2-hydroxyethyl)glycine, N-(phosphonomethyl)-iminodiacetic acid, iminobis(methylenephosphonic acid), D-gluconic acid, tartaric acid, 1-oxopropane-1,2-dicarboxylic acid, propane-1,2,3-tricarboxylic acid, N,N′,N″-tris [2-(N-hydroxycarbamoyl)ethyl]-1,3,5-benzenetricarboxamide (BAMTPH), desferriferrioxamine-B, 1,7-dihydroxy-4-sulfo-2-naphthanoic acid, aspartic acid, glutamic acid, pyridoxal-5-(dihydrogenphosphate), pyridoxal, amino(phenyl)methylene-diphosphoric acid, ethylene glycol tetraacetic acid (EGTA), 1,2 cyclohexanediaminetetraacetic acid (CDTA), ethylenebis(imino-(2-hydroxyphenyl)methylene(methyl)-phosphonic acid)), N-(2-hydroxyethyl)-ethylenedinitrilo-N,N′,N′-triacetic acid, trimethylenedinitrilotetracetic acid, (2-dihydroxytrimethylene)-dinitrilotetracetic acid, xylenol orange, methylthymol blue, 3-hydroxyglutamic acid, L-phosphoserine, DL-amino-3-phosphopropanoic acid, and combinations thereof. These chelating agents may be used in combination with the aforementioned complexing and/or chelating agents to form the at least one complexing agent.

Preferred complexing agents include phosphonic acid and derivatives thereof, salicylic acid and derivatives thereof, other agents having an aluminum complexing power substantially similar to that of salicylic acid (K=13), and combinations thereof. Most preferably, the complexing agents have solubility in water (in a solution including just the complexing agent and water) greater than or equal to about 0.5 wt. %, based on the total weight of the composition. Particularly preferred complexing agents include 2,3-hydroxybenzoic acid, sulfosalicylic acid, HEDP, and combinations thereof.

Illustrative surfactants include, but are not limited to, amphoteric salts, cationic surfactants, anionic surfactants, fluoroalkyl surfactants, non-ionic surfactants, zwitterionic surfactants, and combinations thereof including, but not limited to, SURFONYL® 104, TRITON® CF-21, ZONYL® UR, ZONYL® FSO-100, ZONYL® FSN-100, 3M Fluorad fluorosurfactants (i.e., FC-4430 and FC-4432), PLURONIC® F127 (BASF), PLURONIC® 25R2, PLURAFAC® RA20, Sulfonic P1, PLURONIC® 17R2, PLURONIC®17R4, TERGITOL® Min Foam2x, dioctylsulfosuccinate salt, 2,3-dimercapto-1-propanesulfonic acid salt, dodecylbenzenesulfonic acid, dodecylbenzenesulfonic acid sodium salt (DDBSA), sodium dodecyl sulfonate (SDS), polyethylene glycols, polypropylene glycols, polyethylene or polypropylene glycol ethers, carboxylic acid salts, R₁ benzene sulfonic acids or salts thereof (where the R₁ is a straight-chained or branched C₈-C₁₈ alkyl group), amphiphilic fluoropolymers, polyethylene glycols, polypropylene glycols, polyethylene or polypropylene glycol ethers, carboxylic acid salts, polyacrylate polymers, dinonylphenyl polyoxyethylene, silicone or modified silicone polymers, acetylenic diols or modified acetylenic diols, alkylammonium or modified alkylammonium salts, as well as combinations comprising at least one of the foregoing surfactants, DOWFAX 3B2, sodium dodecyl sulfate, zwitterionic surfactants, aerosol-OT (AOT) and fluorinated analogues thereof, alkyl ammonium, perfluoropolyether surfactants, 2-sulfosuccinate salts, phosphate-based surfactants such as phosphate esters (e.g., KLEARFAC® surfactants such as: KLEARFAC™ AA270 and KLEARFAC™ 870 from BASF; RHODAFAC™ PC100, PO3 and RA600 from Rhone-Poulenc; and CRODAFOS™ N-3, N-10, N2A, N3A, N5A, and N10A from Croda), sulfur-based surfactants, and acetoacetate-based polymers. In a preferred embodiment, the surfactant includes an alkyl benzene sulfonic acid, more preferably dodecylbenzenesulfonic acid. When surfactants are included in the compositions described herein, defoaming agents may be added in a range from 0 to 5 wt. %, based on the total weight of the composition. Defoaming agents contemplated include, but are not limited to, fatty acids, alcohols (simple or polyol) and amines such as caprylic acid diglyceride, lecithin, magnesium carbonate, polyethylene homopolymers and oxidised homopolymer M3400, dimethopolysiloxane-based, silicone-based, AGITAN™, and fatty acid polyether types such as LUMITEN™, oils, and combinations thereof. Preferred surfactants include phosphate esters, PLURONIC® 25R2, PLURAFAC® RA20, Sulfonic P1, PLURONIC® 17R2, PLURONIC®17R4, TERGITOL® Min Foam2x, and combinations thereof.

The cleaning compositions described herein may further include corrosion inhibitors, including, but not limited to, ascorbic acid, adenosine, L(+)-ascorbic acid, isoascorbic acid, ascorbic acid derivatives, benzotriazole (BTA), citric acid, ethylenediamine, gallic acid, oxalic acid, tannic acid, ethylenediaminetetraacetic acid (EDTA), uric acid, 1,2,4-triazole (TAZ), tolyltriazole, 5-phenyl-benzotriazole, 5-nitro-benzotriazole, 3-amino-5-mercapto-1,2,4-triazole, 1-amino-1,2,4-triazole, hydroxybenzotriazole, 2-(5-amino-pentyl)-benzotriazole, 1-amino-1,2,3-triazole, 1-amino-5-methyl-1,2,3-triazole, 3-amino-1,2,4-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, 2-mercaptobenzimidazole (MBI), 2-mercaptobenzothiazole, 4-methyl-2-phenylimidazole, 2-mercaptothiazoline, 5-aminotetrazole, 5-amino-1,3,4-thiadiazole-2-thiol, 2,4-diamino-6-methyl-1,3,5-triazine, thiazole, triazine, methyltetrazole, 1,3-dimethyl-2-imidazolidinone, 1,5-pentamethylenetetrazole, 1-phenyl-5-mercaptotetrazole, diaminomethyltriazine, imidazoline thione, mercaptobenzimidazole, 4-methyl-4H-1,2,4-triazole-3-thiol, 5-amino-1,3,4-thiadiazole-2-thiol, benzothiazole, tritolyl phosphate, imidazole, indiazole, benzoic acid, boric acid, malonic acid, ammonium benzoate, catechol, pyrogallol, resorcinol, hydroquinone, cyanuric acid, barbituric acid and derivatives such as 1,2-dimethylbarbituric acid, alpha-keto acids such as pyruvic acid, adenine, purine, phosphonic acid and derivatives thereof, glycine/ascorbic acid, Dequest 2000, Dequest 7000, p-tolylthiourea, succinic acid, and combinations thereof. For example, the cleaning compositions may include boric acid.

Anti-oxidants contemplated include, but are not limited to, ascorbic acid; adenosine, L(+)-ascorbic acid; isoascorbic acid; ascorbic acid derivatives; cyanuric acid; barbituric acid and derivatives such as 1,2-dimethylbarbituric acid; glucuronic acid; squaric acid; alpha-keto acids such as pyruvic acid; adenosine and derivatives thereof adenine; purine; phosphonic acid and derivatives thereof; phenanthroline/ascorbic acid; glycine/ascorbic acid; nicotinamide and derivatives thereof such as nicotinamide ascorbate; flavonoids such as flavonols and anthocyanins and derivatives thereof; flavonol/anthocyanin; and combinations thereof.

pH buffering agents include, but are not limited to, hydroxides, hydrogen phthalates, acetates, oxalates, carbonates, carbamates, citrates, methyl diethanolamine (MDEA), HCl, phosphoric acid, salicylic acid, boric acid, sulfosalicylic acid, HEDP, sulfamic acid, choline hydroxide, monoethanolamine (MEA), acetylacetone, and combinations thereof.

The compositions described herein have pH in a range from about 1 to about 8, preferably about 1 to about 6, and most preferably about 1 to about 4. The viscosity of the compositions are less than 5 cSt. In a particularly preferred embodiment, the compositions include at least 65 wt. % water, based on the total weight of the composition. Favored compositions are initially substantially devoid of organic solvents, fluoride, amine, abrasive material, compounds having ether bonds, oxidants such as H₂O₂, organic polymer particles, compounds having a structure in which each of two or more adjacent aliphatic carbons atoms has a hydroxyl group, and combinations thereof. As defined herein, “initially devoid” corresponds to a composition that has not yet been in contact with a microelectronic device having residue thereon.

In one embodiment, the compositions comprise, consist of, or consist essentially of about 0.01 wt. % to about 40 wt. % of at least one complexing agent, balance water, based on the total weight of the composition. In another embodiment, the compositions comprise, consist of, or consist essentially of about 0.01 wt. % to about 40 wt. % of at least one complexing agent, about 0.01 wt. % to about 25 wt. % of at least one surfactant, balance water, based on the total weight of the composition. Preferably, the compositions comprise, consist of, or consist essentially of about 10 wt. % to about 20 wt. % of at least one complexing agent, about 1 wt. % to about 8 wt. % of at least one surfactant, balance water, based on the total weight of the composition. In each embodiment, the composition is substantially devoid of organic solvent, amine species, and/or fluoride species.

In various preferred embodiments, the compositions are formulated in the following Formulations A-AZ and B1-B47 wherein the phosphate ester may be KLEARFAC™ AA270, and wherein all percentages are by weight, based on the total weight of the formulation:

Formulation A: 5 wt. % 5-sulfosalicylic acid; 5 wt. % HEDP; 90 wt. % water
Formulation B: 5 wt. % 5-sulfosalicylic acid; 5 wt. % phosphate ester; 90 wt. % water
Formulation C: 5 wt. % phosphate ester; 5 wt. % HEDP; 90 wt. % water
Formulation D: 2 wt. % phosphate ester; 3 wt. % HEDP; 95 wt. % water
Formulation E: 10 wt. % phosphate ester; 3 wt. % HEDP; 87 wt. % water
Formulation F: 2 wt. % phosphate ester; 12 wt. % HEDP; 86 wt. % water
Formulation G: 10 wt. % phosphate ester; 12 wt. % HEDP; 78 wt. % water
Formulation H: 8 wt. % 5-sulfosalicylic acid; 2 wt. % phosphate ester; 3 wt. % HEDP; 87 wt. % water
Formulation I: 8 wt. % 5-sulfosalicylic acid; 10 wt. % phosphate ester; 3 wt. % HEDP; 79 wt. % water
Formulation J: 8 wt. % 5-sulfosalicylic acid; 2 wt. % phosphate ester; 12 wt. % HEDP; 78 wt. % water
Formulation K: 8 wt. % 5-sulfosalicylic acid; 10 wt. % phosphate ester; 12 wt. % HEDP; 70 wt. % water
Formulation L: 4 wt. % 5-sulfosalicylic acid; 6 wt. % phosphate ester; 7.5 wt. % HEDP; 82.5 wt. % water
Formulation M: 6 wt. % phosphate ester; 7.5 wt. % HEDP; 86.5 wt. % water
Formulation N: 8 wt. % 5-sulfosalicylic acid; 6 wt. % phosphate ester; 7.5 wt. % HEDP; 78.5 wt. % water

Formulation O: 4 wt. % 5-sulfosalicylic acid; 6 wt. % phosphate ester; 3 wt. % HEDP; 87 wt. % water

Formulation P: 4 wt. % 5-sulfosalicylic acid; 6 wt. % phosphate ester; 12 wt. % HEDP; 78 wt. % water
Formulation Q: 4 wt. % 5-sulfosalicylic acid; 2 wt. % phosphate ester; 7.5 wt. % HEDP; 86.5 wt. % water
Formulation R: 4 wt. % 5-sulfosalicylic acid; 10 wt. % phosphate ester; 7.5 wt. % HEDP; 78.5 wt. % water
Formulation S: 3 wt. % 5-sulfosalicylic acid; 0.2 wt. % boric acid; 96.8 wt. % water; pH 0-1
Formulation T: 3 wt. % 5-sulfosalicylic acid; 0.2 wt. % boric acid; 0.2 wt. % salicylic acid; 96.6 wt. % water; pH 0-1
Formulation U: 2 wt. % salicylic acid; 8 wt. % phosphate ester; 5 wt. % PLURONIC® F127; 85 wt. % water
Formulation V: 3 wt. % 5-sulfosalicylic acid; 3.6 wt. % Dequest 2016D (solid); 93.4 wt. % water; pH ˜3.2
Formulation W: 5 wt. % HEDP; 4.3 wt. % Dequest 2016D (solid); 90.7 wt. % water; pH ˜3.3
Formulation X: 3 wt. % 5-sulfosalicylic acid; 5 wt. % HEDP; 8 wt. % Dequest 2016D (solid); 84 wt. % water; pH ˜3.4
Formulation Y: 5 wt. % 5-sulfosalicylic acid; 5 wt. % HEDP; 0.4 wt. % 3-amino-5-mercapto-1,2,4-triazole; 89.6 wt. % water
Formulation Z: 5 wt. % 5-sulfosalicylic acid; 5 wt. % HEDP; 0.4 wt. % ascorbic acid; 89.6 wt. % water
Formulation AA: 5 wt. % 5-sulfosalicylic acid; 5 wt. % phosphate ester; 0.4 wt. % 3-amino-5-mercapto-1,2,4-triazole; 89.6 wt. % water
Formulation AB: 5 wt. % 5-sulfosalicylic acid; 5 wt. % HEDP; 0.4 wt. % 3-amino-5-mercapto-1,2,4-triazole; 2 wt. % phosphate ester; 87.6 wt. % water
Formulation AC: 5 wt. % 5-sulfosalicylic acid; 5 wt. % HEDP; 0.8 wt. % 3-amino-5-mercapto-1,2,4-triazole; 89.2 wt. % water

Formulation AD: 5 wt. % 5-sulfosalicylic acid; 5 wt. % phosphate ester; 0.8 wt. % ascorbic acid; 89.2 wt. % water

Formulation AE: 5 wt. % 5-sulfosalicylic acid; 5 wt. % phosphate ester; 0.8 wt. % 3-amino-5-mercapto-1,2,4-triazole; 89.2 wt. % water
Formulation AF: 8 wt. % 5-sulfosalicylic acid; 3 wt. % HEDP; 0.8 wt. % 3-amino-5-mercapto-1,2,4-triazole; 2 wt. % phosphate ester; 86.2 wt. % water
Formulation AG: 5 wt. % 5-sulfosalicylic acid; 5 wt. % HEDP; 0.2 wt. % ascorbic acid; 89.8 wt. % water
Formulation AH: 5 wt. % HEDP; 5 wt. % 5-sulfosalicylic acid, less than 1 wt. % choline hydroxide; approximately 90 wt. % water; pH 3
Formulation AI: 5 wt. % HEDP; 5 wt. % 5-sulfosalicylic acid, less than 7 wt. % choline hydroxide; approximately 83 wt. % water, pH=7.5
Formulation AJ: 5 wt. % HEDP; 5 wt. % 5-sulfosalicylic acid, approximately 2.2 wt. % choline hydroxide; less than 90 wt. % water; pH 2
Formulation AK: 5 wt. % HEDP; 5 wt. % 5-sulfosalicylic acid; 0.2 wt. % ascorbic acid; approximately 2 wt. % choline hydroxide; less than 90 wt. % water; pH 2
Formulation AL: 5 wt. % HEDP; 5 wt. % 5-sulfosalicylic acid, approximately 1.6 wt. % monoethanolamine; less than 90 wt. % water; pH 3
Formulation AM: 5 wt. % HEDP; 5 wt. % 5-sulfosalicylic acid, approximately 0.1 wt. % monoethanolamine; less than 90 wt. % water; pH 2
Formulation AN: 5 wt. % HEDP; 5 wt. % 5-sulfosalicylic acid, approximately 2 wt. % monoethanolamine; less than 90 wt. % water; pH 4
Formulation AO: 3 wt. % HEDP; 8 wt. % 5-sulfosalicylic acid, 2 wt. % phosphate ester; less than 87 wt. % water
Formulation AP: 8 wt. % 5-sulfosalicylic acid; 3 wt. % HEDP; 0.8 wt. % ascorbic acid; 2 wt. % phosphate ester; 86.2 wt. % water
Formulation AQ: 8 wt. % 5-sulfosalicylic acid; 3 wt. % HEDP; 1.2 wt. % ascorbic acid; 2 wt. % phosphate ester; 85.8 wt. % water
Formulation AR: 5 wt. % 5-sulfosalicylic acid; 5 wt. % HEDP; 1.2 wt. % ascorbic acid; 8.8 wt. % water
Formulation AS: 5 wt. % 5-sulfosalicylic acid; 5 wt. % HEDP; 0.8 wt. % ascorbic acid; 89.2 wt. % water
Formulation AT: 8 wt. % 5-sulfosalicylic acid; 3 wt. % HEDP; 2 wt. % phosphate ester; 5 wt. % acetylacetone; 82 wt. % water
Formulation AU: 8 wt. % 5-sulfosalicylic acid; 3 wt. % HEDP; 2 wt. % phosphate ester; 2.5 wt. % MEA; 84.5 wt. % water; pH=3.17
Formulation AV: 5 wt. % 5-sulfosalicylic acid; 5 wt. % HEDP; 2.4 wt. % MEA; 87.6 wt. % water; pH=3.34
Formulation AW: 8 wt. % 5-sulfosalicylic acid; 3 wt. % HEDP; 2 wt. % phosphate ester; 0.1 wt. % HCl; 86.9 wt. % water
Formulation AX: 8 wt. % 5-sulfosalicylic acid; 3 wt. % HEDP; 2 wt. % phosphate ester; 1 wt. % HCl; 86 wt. % water
Formulation AY: 4% Sulfosalicylic acid; 96% monoethanolamine (MEA); pH=9
Formulation AZ: 3% Sulfosalicylic acid; 97% monoethanolamine (MEA); pH=10.5

| | | wt. % 5- | wt. % | | | | |
|---|---|---|---|---|---|---|---|
| | wt. % | sulfosalicylic | additional | wt. % | wt. % pH | wt. % | |
| Formulation | DMSO | acid | chelator | surfactant | buffer | water | pH |
| B1 | 10 | 5 | | | | 85 | 0.85 |
| B2 | 20 | 5 | | | | 75 | 1.2 |
| B3 | 25 | 5 | | | | 70 | 0.795 |
| B4 | 30 | 5 | | | | 65 | 1.2 |
| B5 | 25 | 2.5 | | | | 72.5 | |
| B6 | 25 | 1 | | | | 74 | |
| B7 | 25 | 5 | 1.2 ascorbic | | | 68.8 | 0.91 |
| | | | acid | | | | |
| B8 | 25 | 5 | 0.8 ascorbic | | | 69.2 | 0.9 |
| | | | acid | | | | |
| B9 | 25 | 5 | 0.1 BTA | | | 69.9 | 0.86 |
| B10 | 25 | 5 | 0.5 BTA | | | 69.5 | 0.814 |
| B11 | 25 | 5 | 0.3 BTA | 0.1 SDS | | 69.6 | |
| B12 | 25 | 5 | 0.3 BTA | 0.1 | | 69.6 | |
| | | | | DDBSA | | | |
| B13 | 25 | 5 | 0.3 BTA | 0.1 Dowfax | | 69.6 | |
| | | | | 3B2 | | | |
| B14 | 25 | 5 | 0.3 p- | 0.1 SDS | | 69.6 | |
| | | | tolylthiourea | | | | |
| B15 | 25 | 5 | 0.3 p- | 0.1 | | 69.6 | |
| | | | tolylthiourea | DDBSA | | | |
| B16 | 25 | 5 | 0.3 p- | 0.1 Dowfax | | 69.6 | |
| | | | tolylthiourea | 3B2 | | | |
| B17 | 25 | 5 | | 0.3 SDS | | 69.7 | |
| B18 | 25 | 5 | | 0.3 | | 69.7 | |
| | | | | DDBSA | | | |
| B19 | 25 | 5 | | 0.3 Dowfax | | 69.7 | |
| | | | | 3B2 | | | |
| B20 | 5 | | | 5 | | 90 | |
| | | | | phosphate | | | |
| | | | | ester | | | |
| B21 | 40 | 5 | | | | 55 | |
| B22 | 50 | 5 | | | | 45 | |
| B23 | 60 | 5 | | | | 35 | |
| B24 | 40 | 5 | | 2 | | 53 | |
| | | | | phosphate | | | |
| | | | | ester | | | |
| B25 | 40 | 8 | 3 HEDP | 2 | | 47 | |
| | | | | phosphate | | | |
| | | | | ester | | | |
| B26 | 40 | 8 | 0.8 3- | 2 | 3 HEDP | 46.2 | |
| | | | amino-5- | phosphate | | | |
| | | | mercapto- | ester | | | |
| | | | 1,2,4- | | | | |
| | | | triazole | | | | |
| B27 | 40 | 5 | 1 | | | 54 | |
| | | | ammonium | | | | |
| | | | chloride | | | | |
| B28 | 40 | 5 | 0.25 | | | 54.75 | |
| | | | ammonium | | | | |
| | | | chloride | | | | |
| B29 | 40 | 5 | 1 | | | 54 | |
| | | | alkyldibenzyl | | | | |
| | | | ammonium | | | | |
| | | | chloride | | | | |
| B30 | 40 | 5 | 0.25 | | | 54.75 | |
| | | | alkyldibenzyl | | | | |
| | | | ammonium | | | | |
| | | | chloride | | | | |
| B31 | 40 | 5 | 1 KCl | | | 54 | |
| B32 | 40 | 5 | 0.25 KCl | | | 54.75 | |
| B33 | 40 | 5 | 2 | | | 53 | |
| | | | ammonium | | | | |
| | | | chloride | | | | |
| B34 | 40 | 5 | 3 | | | 52 | |
| | | | ammonium | | | | |
| | | | chloride | | | | |
| B35 | 40 | 5 | 2 KCl | | | 53 | |
| B36 | 40 | 5 | 3KCl | | | 52 | |
| B37 | 40 | 5 | | | 5 acetyl | 50 | |
| | | | | | acetone | | |
| B38 | 40 | 5 | | | 4.2 MEA | 50.8 | 3.11 |
| B39 | 40 | 5 | 0.1 | | | 54.9 | |
| | | | ammonium | | | | |
| | | | fluoride | | | | |
| B40 | 40 | 5 | 0.5 | | | 54.5 | |
| | | | ammonium | | | | |
| | | | fluoride | | | | |
| B41 | 40 | 5 | 1 | | | 54 | |
| | | | ammonium | | | | |
| | | | fluoride | | | | |
| B42 | 40 | 5 | 1.5 | | | 53.5 | |
| | | | ammonium | | | | |
| | | | fluoride | | | | |
| B43 | 40 | 5 | 0.1 HCl | | | 54.9 | |
| B44 | 40 | 5 | 1 HCl | | | 54 | |
| B45 | | 5 | | 5 | 3.7 MEA | 86.3 | 3.24 |
| | | | | phosphate | | | |
| | | | | ester | | | |
| B46 | | 5 | 0.4 ascorbic | 5 | 3.5 MEA | 86.1 | 3.02 |
| | | | acid | phosphate | | | |
| | | | | ester | | | |
| B47 | | 5 | 0.8 ascorbic | 5 | 3.7 MEA | 85.5 | 3.48 |
| | | | acid | phosphate | | | |
| | | | | ester | | | |

The range of weight percent ratios of the components of the composition is: about 0.1 to about 15 complexing agent(s) relative to surfactant(s), preferably about 1 to about 10, and most preferably about 2 to about 7.

In another embodiment, the aforementioned compositions further include residue material selected from the group consisting of post-etch residue, post-ash residue, post-CMP residue, wet etch residue, and combinations thereof. For example, the composition may include at least one complexing agent and residue material. In another embodiment, the composition may include at least one complexing agent, at least one surfactant, and residue material. The residue material may be dissolved and/or suspended in the removal composition described herein.

In still another embodiment, the composition comprises, consists of, or consists essentially of 5-sulfosalicylic acid, boric acid, and greater than about 95 wt. % water, more preferably greater than about 96 wt. % water, based on the total weight of the composition. This embodiment is substantially devoid of organic solvent, amine species, and/or fluoride species.

In a particularly preferred embodiment, the composition comprises, consists essentially of, or consists of 5-sulfosalicylic acid (SSA), HEDP, phosphate ester, and water, wherein the composition is useful for the removal of residue material, and wherein the composition is substantially devoid of organic solvent, amine species, and/or fluoride species. The composition has pH in a range from about 3 to about 4. The weight percent ratio of SSA to phosphate ester is in a range from about 0.1:1 to about 10:1, preferably about 0.5:1 to about 8:1, and most preferably about 1:1 to about 5:1. The weight percent ratio of SSA to HEDP is in a range from about 0.01:1 to about 10:1, preferably about 0.1:1 to about 8:1, and most preferably about 0.3:1 to about 2:1.

In another preferred embodiment, the composition comprises, consists essentially of, or consists of DMSO, 5-sulfosalicylic acid (SSA) and water, wherein the composition is useful for the removal of residue material. The weight percent ratio of DMSO to SSA is in a range from about 1:1 to about 50:1, preferably about 5:1 to about 25:1. In still another preferred embodiment, the composition comprises, consists essentially of, or consists of DMSO, 5-sulfosalicylic acid (SSA), ascorbic acid, and water, wherein the composition is useful for the removal of residue material. The weight percent ratio of DMSO to SSA is in a range from about 1:1 to about 10:1, preferably about 3:1 to about 7:1 and the weight percent ratio of DMSO to ascorbic acid is in a range from about 15:1 to about 40:1, preferably about 20:1 to about 32:1. In yet another preferred embodiment, the composition comprises, consists essentially of, or consists of DMSO, 5-sulfosalicylic acid, BTA and water, wherein the composition is useful for the removal of residue material. The weight percent ratio of DMSO to SSA is in a range from about 1:1 to about 10:1, preferably about 3:1 to about 7:1 and the weight percent ratio of DMSO to BTA is in a range from about 20:1 to about 300:1, preferably about 50:1 to about 250:1. Yet another preferred embodiment relates to a composition comprising, consisting essentially of, or consisting of DMSO, 5-sulfosalicylic acid, phosphate ester, and water, wherein the composition is useful for the removal of residue material.

In another aspect, the removal composition is formulated to remove residue, contaminants and/or polymeric materials, e.g., photoresist. The removal composition of this aspect broadly includes at least one complexing agent and at least one solvent, wherein the removal composition is useful for the removal of material selected from the group consisting of residue, contaminants, polymeric materials, and combinations thereof, from the surface of a microelectronic device having same thereon. Preferably, the removal composition of this aspect comprises, consists of, or consists essentially of at least one complexing agent, at least one solvent, and at least one surfactant. It is to be appreciated that as the amount of solvent in the composition increases, the efficacy at removing polymeric material and/or contaminants increases while the efficacy at removing the residue material decreases. Each embodiment of this aspect may further include a buffering agent, at least one corrosion inhibitor, at least one anti-oxidant, and combinations thereof. When the composition is formulated to remove photoresist, the formulation may include at least one organic solvent and/or at least one amine-containing solvent.

The organic solvents that may be added to the compositions of this aspect include, but are not limited to, alcohols, ethers, pyrrolidinones, glycols, carboxylic acids, glycol ethers, amines, ketones, esters, aldehydes, alkanes, alkenes, alkynes, and amides, more preferably alcohols, ethers, pyrrolidinones, glycols, carboxylic acids, and glycol ethers such as methanol, ethanol, isopropanol, butanol, tetrahydrofurfuryl alcohol, and higher alcohols (including diols, triols, etc.), 2,2,3,3,4,4,5,5-octafluoro-1-pentanol, 1H,1H,9H-perfluoro-1-nonanol, perfluoroheptanoic acid, 1H,1H,7H-dodecafluoro-1-heptanol, perfluoropentanoic acid, 1H,1H,8H,8H-dodecafluoro-1,8-octanediol, 2,2,3,3,4,4,5,5-octafluoro-1,6-hexanediol, dibasic ester, 5H-perfluoropentanoic acid, n-butyl heptafluorobutyrate, tetrahydrofuran (THF), N-methylpyrrolidinone (NMP), cyclohexylpyrrolidinone, N-octylpyrrolidinone, N-phenylpyrrolidinone, monoethanolamine, methyl formate, dimethyl formamide (DMF), dimethylsulfoxide (DMSO), tetramethylene sulfone (sulfolane), diethyl ether, phenoxy-2-propanol (PPh), propriophenone, ethyl lactate, ethyl acetate, ethyl benzoate, acetonitrile, acetone, ethylene glycol, propylene glycol, dioxane, butyryl lactone, butylene carbonate, ethylene carbonate, propylene carbonate, glycerin carbonate, dipropylene glycol, amphiphilic species (diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof), branched fluorinated or non-fluorinated ether-linkage carboxylic acids (CH₃CH₂)ₙO(CH₂)ₘCOOH, where n=1 to 10 and m=1 to 10), unbranched fluorinated or non-fluorinated ether-linkage carboxylic acids (CH₃CH₂)ₙO(CH₂)ₘCOOH, where n=1 to 10 and m=1 to 10), branched fluorinated or non-fluorinated non-ether linkage carboxylic acids (CH₃(CH₂)ₙCOOH, where n=1 to 10), unbranched fluorinated or non-fluorinated non-ether linkage carboxylic acids (CH₃(CH₂)ₙCOOH, where n=1 to 10), dicarboxylic acids, tricarboxylic acids, and combinations thereof. Alternatively, or in addition to, the solvent may include at least one quaternary base such as quaternary ammonium hydroxides having the formula NR¹R²R³R⁴OH, wherein R¹, R², R³ and R⁴ may be the same as or different from one another and are selected from the group consisting of hydrogen, straight-chained or branched C₁-C₆ alkyl (e.g., methyl, ethyl, propyl, butyl, pentyl, and hexyl), and substituted or unsubstituted C₆-C₁₀ aryl, e.g., benzyl. Preferably, the solvent comprises DMSO, ethyl lactate, tetramethylammonium hydroxide, choline, dibasic esters, glycerin carbonate, tetrahydrofurfuryl alcohol, and combinations thereof.

The compositions described herein are compatible with low-k dielectric and metal-containing materials on the microelectronic device. Furthermore, the compositions are water soluble, non-corrosive, non-flammable and of low toxicity to the environment. Given the low viscosity, the compositions described herein may be used in single wafer (as well as batch wafer) tool sets which is a significant advance over the amine-containing cleaners in the art.

The range of weight percent ratios of the components will cover all possible concentrated or diluted embodiments of the composition. Towards that end, in one embodiment, a concentrated composition is provided that can be diluted for use as a diluted composition. A concentrated composition, or “concentrate,” advantageously permits a user, e.g. a process engineer, to dilute the concentrate to the desired strength and pH at the point of use. Dilution of the concentrated composition may be in a range from about 1:1 to about 2500:1, preferably about 5:1 to about 200:1, wherein the composition is diluted at or just before the tool with solvent, e.g., deionized water. It is to be appreciated by one skilled in the art that following dilution, the range of weight percent ratios of the components disclosed herein should remain unchanged.

The compositions described herein may have utility in applications including, but not limited to, post-etch residue removal, post-ash residue removal surface preparation, post-plating cleaning and/or post-CMP residue removal.

The compositions described herein are easily formulated by simple addition of the respective ingredients and mixing to homogeneous condition. Furthermore, the compositions may be readily formulated as single-package formulations or multi-part formulations that are mixed at or before the point of use, e.g., the individual parts of the multi-part formulation may be mixed at the tool or in a storage tank upstream of the tool. The concentrations of the respective ingredients may be widely varied in specific multiples of the composition, i.e., more dilute or more concentrated, and it will be appreciated that the compositions described herein can variously and alternatively comprise, consist or consist essentially of any combination of ingredients consistent with the disclosure herein.

Accordingly, another aspect relates to a kit including, in one or more containers, one or more components adapted to form the compositions described herein. The kit may include, in one or more containers, at least one complexing agent, and optionally at least one additional component selected from the group consisting of at least one surfactant, at least one corrosion inhibitor, a pH buffering agent, at least one anti-oxidant, water, and combinations thereof, for combining with additional solvent, e.g., water, at the fab or the point of use. Alternatively, the kit may include, in one or more containers, at least one complexing agent and at least one surfactant, and optionally at least one additional component selected from the group consisting of at least one corrosion inhibitor, a pH buffering agent, at least one anti-oxidant, water, and combinations thereof, for combining with additional solvent, e.g., water, at the fab or the point of use.

The containers of the kit should be chemically rated to store and dispense the component(s) contained therein. For example, the containers of the kit may be NOWPak® containers (Advanced Technology Materials, Inc., Danbury, Conn., USA). The one or more containers which contain the components of the removal composition preferably include means for bringing the components in said one or more containers in fluid communication for blending and dispense. For example, referring to the NOWPak® containers, gas pressure may be applied to the outside of a liner in said one or more containers to cause at least a portion of the contents of the liner to be discharged and hence enable fluid communication for blending and dispense. Alternatively, gas pressure may be applied to the head space of a conventional pressurizable container or a pump may be used to enable fluid communication. In addition, the system preferably includes a dispensing port for dispensing the blended removal composition to a process tool.

Substantially chemically inert, impurity-free, flexible and resilient polymeric film materials, such as high density polyethylene, are preferably used to fabricate the liners for said one or more containers. Desirable liner materials are processed without requiring co-extrusion or barrier layers, and without any pigments, UV inhibitors, or processing agents that may adversely affect the purity requirements for components to be disposed in the liner. A listing of desirable liner materials include films comprising virgin (additive-free) polyethylene, virgin polytetrafluoroethylene (PTFE), polypropylene, polyurethane, polyvinylidene chloride, polyvinylchloride, polyacetal, polystyrene, polyacrylonitrile, polybutylene, and so on. Preferred thicknesses of such liner materials are in a range from about 5 mils (0.005 inch) to about 30 mils (0.030 inch), as for example a thickness of 20 mils (0.020 inch).

Regarding the containers for the kits, the disclosures of the following patents and patent applications are hereby incorporated herein by reference in their respective entireties: U.S. Pat. No. 7,188,644 entitled “APPARATUS AND METHOD FOR MINIMIZING THE GENERATION OF PARTICLES IN ULTRAPURE LIQUIDS;” U.S. Pat. No. 6,698,619 entitled “RETURNABLE AND REUSABLE, BAG-IN-DRUM FLUID STORAGE AND DISPENSING CONTAINER SYSTEM;” and U.S. Patent Application No. 60/916,966 entitled “SYSTEMS AND METHODS FOR MATERIAL BLENDING AND DISTRIBUTION” filed on May 9, 2007 in the name of John E.Q. Hughes.

As applied to microelectronic manufacturing operations, the compositions described herein are usefully employed to clean residue from the surface of the microelectronic device. Preferably, the compositions do not damage low-k dielectric materials or corrode metal interconnects on the device surface. Preferably the compositions remove at least 85% of the residue present on the device prior to residue removal, more preferably at least 90%, even more preferably at least 95%, and most preferably at least 99%.

In residue cleaning application, the composition may be used with a large variety of conventional cleaning tools such as megasonics and brush scrubbing, including, but not limited to, Verteq single wafer megasonic Goldfinger, OnTrak systems DDS (double-sided scrubbers), SEZ single wafer spray rinse, Applied Materials Mirra-Mesa™/Reflexion™/Reflexion LK™, and Megasonic batch wet bench systems.

In use of the compositions described herein for removing residue from microelectronic devices having same thereon, the composition typically is contacted with the device for a time of from about 5 sec to about 20 minutes, preferably about 1 min to 10 min, at temperature in a range of from about 20° C. to about 50° C. Such contacting times and temperatures are illustrative, and any other suitable time and temperature conditions may be employed that are efficacious to at least partially clean the residue from the device. “At least partially clean” and “substantial removal” both correspond to at removal of at least 85% of the residue present on the device prior to residue removal, more preferably at least 90%, even more preferably at least 95%, and most preferred at least 99%

Following the achievement of the desired cleaning action, the composition may be readily removed from the device to which it has previously been applied, as may be desired and efficacious in a given end use application of the compositions described herein. Preferably, the rinse solution includes deionized water. Thereafter, the device may be dried using nitrogen or a spin-dry cycle.

Yet another aspect relates to the improved microelectronic devices made according to the methods described herein and to products containing such microelectronic devices.

Another aspect relates to a recycled composition, wherein the composition may be recycled until residue and/or contaminant loading reaches the maximum amount the composition may accommodate, as readily determined by one skilled in the art.

A still further aspect relates to methods of manufacturing an article comprising a microelectronic device, said method comprising contacting the microelectronic device with a composition for sufficient time to clean residue from the microelectronic device having said residue and contaminants thereon, and incorporating said microelectronic device into said article, using a composition described herein.

The features and advantages are more fully shown by the illustrative examples discussed below.

### Example 1

Blanketed TiN, TEOS, AlCu, Cu, SiN, Ti and W wafers were immersed Formulation H at 25° C., 35° C., 45° C. or 55° C. for 30 min and the etch rate of each material determined. The etch rate of AlCu, W, TiN, Ti and Cu was determined using a 4-point probe, whereby the thickness of the wafer was measured before an after static immersion at the reported temperature and time. The etch rate of SiN and TEOS was determined using a Nanospec, whereby the thickness of the wafer was measured before an after static immersion at the reported temperature and time. The results are summarized in Table 1 below.

TABLE 1
Etch rates of TiN, TEOS, AlCu, Cu, SiN, Ti and W following immersion in
Formulation H.

| | Etch rate | Etch rate | Etch rate | | | | |
|---|---|---|---|---|---|---|---|
| Temperature/ | TiN/Å | TEOS/Å | AlCu/Å | Etch rate | Etch rate | Etch rate | Etch rate |
| ° C. | min⁻¹ | min⁻¹ | min⁻¹ | Cu/Å min⁻¹ | SiN/Å min⁻¹ | Ti/Å min⁻¹ | W/Å min⁻¹ |
| 25 | 0.67 | 0.00 | 0.48 | 3.57 | 0 | 0 | 0 |
| 25 | 0.65 | 0.00 | 0.66 | 3.03 | 0 | 0 | 0.13 |
| 35 | 10.34 | 0.03 | 0.85 | 5.17 | 0 | 0 | 0.07 |
| 35 | 10.65 | 0.20 | 0.66 | 4.67 | 0 | 0 | 0 |
| 45 | 36.06 | 0.20 | 7.69 | 5.43 | 0 | 0 | 0.13 |
| 45 | 35.38 | 0.00 | 6.22 | 5.67 | 0 | 0 | 0.23 |
| 55 | 75.66 | 0.03 | 18.06 | 7.33 | 0 | 0 | 0.23 |
| 55 | 77.57 | 0.03 | 16.63 | 7.93 | 0 | 0 | 0.33 |

It can be seen that the etch rate of every material tested was very low at temperatures of 35° C. or below. Notably, a patterned wafer (including TEOS, Ti, TiN, Al(Cu 0.5%) and TiN) having residue thereon was immersed in Formulations H and N at 25° C. for 10 min and the residue material was substantially removed as observed using scanning electron microscopy. Advantageously, the formulations described herein substantially removed residue, without damaging the metal and silicon-containing materials present, at low temperatures, which translates to a low thermal budget and lower processing costs relative to HDA-containing compositions in the art. Moreover, the formulations are substantially devoid of fluoride ions and as such, can be used in the quartz tool sets already used in the art.

### Example 2

Blanketed TiN, TEOS, AlCu, and/or Cu wafers were immersed Formulations AD, B3-B10 and AO at 40° C. for 30 min and the etch rate of each material determined. The etch rate of AlCu, TiN, and Cu was determined using a 4-point probe, whereby the thickness of the wafer was measured before an after static immersion at the reported temperature and time. The etch rate of TEOS was determined using a Nanospec, whereby the thickness of the wafer was measured before an after static immersion at the reported temperature and time. The results are summarized in Table 2 below.

TABLE 2
Etch rates of TiN, TEOS, AlCu, and Cu following immersion
in Formulations AD, B3-B10 and AO.

| | Etch rate | Etch rate | Etch rate | |
|---|---|---|---|---|
| | TiN/Å | TEOS/Å | AlCu/Å | Etch rate |
| Formulation | min⁻¹ | min⁻¹ | min⁻¹ | Cu/Å min⁻¹ |
| AD | 0.1 | 0.1 | 0 | — |
| B3 | 0 | 0 | 4 | 0 |
| B4 | 0 | 0 | 0 | — |
| B5 | 0 | 0 | 0.6 | — |
| B6 | 0 | 0 | 0.2 | — |
| B7 | — | — | 2.8 | 1.2 |
| B8 | — | — | 0.4 | 1.4 |
| B9 | — | — | 0 | 4.4 |
| B10 | — | — | 0 | 8.6 |
| AO | 0.1 | 0.2 | 0 | — |

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. A removal composition including at least one complexing agent, at least one surfactant, and water, wherein the composition is substantially devoid of amine and fluoride species, and wherein the composition is useful for removing residue material(s) from a microelectronic device having same thereon.

2. (canceled)

3. The removal composition of claim 1, wherein the at least one complexing agent comprises a compound selected from the group consisting of (ethylenedinitrilo)tetraacetic acid, butylenediaminetetraacetic acid, (1,2-cyclohexylenedinitrilo)tetraacetic acid, diethylenetriaminepentaacetic acid, ethylenediaminetetrapropionic acid, (hydroxyethyl)ethylenediaminetriacetic acid, N,N,N′,N′-ethylenediaminetetra(methylenephosphonic)acid, triethylenetetraminehexaacetic acid, 1,3-diamino-2-hydroxypropane-N,N,N′,N′-tetraacetic acid, methyliminodiacetic acid, propylenediaminetetraacetic acid, 1,5,9-triazacyclododecane-N,N′,N″-tris(methylenephosphonic acid), 1,4,7,10-tetraazacyclododecane-N,N′,N″,N′″-tetrakis(methylenephosphonic acid), nitrilotris(methylene)triphosphonic acid, diethylenetriaminepenta(methylenephosphonic acid), aminotri(methylenephosphonic acid), 1-hydroxyethylidene-1,1-diphosphonic acid, bis(hexamethylene)triamine phosphonic acid, 1,4,7-triazacyclononane-N,N′,N″-tris(methylenephosphonic acid, 2-phosphonobutane-1,2,4-tricarboxylic acid, nitrilotriacetic acid, citric acid, tartaric acid, gluconic acid, saccharic acid, glyceric acid, oxalic acid, phthalic acid, maleic acid, mandelic acid, malonic acid, lactic acid, o-, m-, or p-salicylic acid, dihydroxybenzoic acid, 5-sulfosalicylic acid, catechol, gallic acid, propyl gallate, pyrogallol, 8-hydroxyquinoline, cysteine, phosphoric acid, nitric acid, sulfuric acid, hydrochloric acid, hydrofluoric acid, alkyldimethylbenzylammonium chloride, ammonium chloride, potassium chloride, ammonium fluoride, and combinations thereof.

4. The removal composition of claim 1, wherein the at least one complexing agent comprises species selected from the group consisting of 5-sulfosalicylic acid, 1-hydroxyethylidene-1,1-diphosphonic acid (HEDP), and combinations thereof.

5. (canceled)

6. The removal composition of claim 5, wherein the at least one surfactant comprises a species selected from the group consisting of an anionic surfactant, a cationic surfactant, a non-ionic surfactant, a zwitterionic surfactant, and combinations thereof.

7. (canceled)

8. The removal composition of claim 5, wherein the at least one surfactant comprises an anionic phosphate ester surfactant.

9. (canceled)

10. The removal composition of claim 1, further comprising at least one additional component selected from the group consisting of at least one corrosion inhibitor, at least one buffering agent, at least one anti-oxidant, and combinations thereof.

11. The removal composition of claim 1, wherein the removal composition has pH in a range from about 1 to about 6.

12. The removal composition of claim 1, wherein said composition is initially substantially devoid of organic solvents, abrasive material, compounds having ether bonds, oxidants, organic polymer particles, compounds having a structure in which each of two or more adjacent aliphatic carbons atoms has a hydroxyl group, and combinations thereof.

13. The removal composition of claim 1, comprising a salicylic acid derivative and a phosphonic acid derivative.

14. The removal composition of claim 1, comprising 5-sulfosalicyclic acid, 1-hydroxyethylidene-1,1-diphosphonic acid, and a phosphate ester surfactant.

15. (canceled)

16. The removal composition of claim 1, comprising dimethyl sulfoxide, 5-sulfosalicylic acid, and water.

17. The removal composition of claim 16, further comprising benzotriazole or ascorbic acid.

18. The removal composition of claim 1, wherein said composition further comprises residue material(s) selected from the group consisting of post-etch residue, post-ash residue, post-CMP residue, and combinations thereof.

19. A kit comprising, in one or more containers, one or more of the following reagents for forming a removal composition, said one or more reagents selected from the group consisting of at least complexing agent, optionally at least one surfactant, optionally at least one corrosion inhibitor, optionally at least one buffering agent, and optionally at least one anti-oxidant, and wherein the kit is adapted to form a removal composition suitable for removing residue from a microelectronic device having said residue thereon.

20. A method of removing residue from a microelectronic device having said residue thereon, said method comprising contacting the microelectronic device with an aqueous removal composition for sufficient time to at least partially remove said residue from the microelectronic device, wherein the removal composition includes at least complexing agent, at least one surfactant, water, optionally at least one corrosion inhibitor, optionally at least one buffering agent, and optionally at least one anti-oxidant.

21. (canceled)

22. (canceled)

23. The method of claim 20, wherein the at least one complexing agent comprises a compound selected from the group consisting of (ethylenedinitrilo)tetraacetic acid, butylenediaminetetraacetic acid, (1,2-cyclohexylenedinitrilo)tetraacetic acid, diethylenetriaminepentaacetic acid, ethylenediaminetetrapropionic acid, (hydroxyethyl)ethylenediaminetriacetic acid, N,N,N′,N′-ethylenediaminetetra(methylenephosphonic)acid, triethylenetetraminehexaacetic acid, 1,3-diamino-2-hydroxypropane-N,N,N′,N′-tetraacetic acid, methyliminodiacetic acid, propylenediaminetetraacetic acid, 1,5,9-triazacyclododecane-N,N′,N″-tris(methylenephosphonic acid), 1,4,7,10-tetraazacyclododecane-N,N′,N″,N′″-tetrakis(methylenephosphonic acid), nitrilotris(methylene)triphosphonic acid, diethylenetriaminepenta(methylenephosphonic acid), aminotri(methylenephosphonic acid), 1-hydroxyethylidene-1,1-diphosphonic acid, bis(hexamethylene)triamine phosphonic acid, 1,4,7-triazacyclononane-N,N′,N″-tris(methylenephosphonic acid, 2-phosphonobutane-1,2,4-tricarboxylic acid, nitrilotriacetic acid, citric acid, tartaric acid, gluconic acid, saccharic acid, glyceric acid, oxalic acid, phthalic acid, maleic acid, mandelic acid, malonic acid, lactic acid, o-, m-, or p-salicylic acid, dihydroxybenzoic acid, 5-sulfosalicylic acid, catechol, gallic acid, propyl gallate, pyrogallol, 8-hydroxyquinoline, cysteine, phosphoric acid, nitric acid, sulfuric acid, hydrochloric acid, hydrofluoric acid, alkyldimethylbenzylammonium chloride, ammonium chloride, potassium chloride, ammonium fluoride, and combinations thereof.

24. The method of claim 20, wherein said contacting comprises conditions selected from the group consisting of: time of from about 1 minute to about 10 minutes; temperature in a range of from about 20° C. to about 50° C.; and combinations thereof.

25. The method of claim 20, wherein the microelectronic device is of an article selected from the group consisting of semiconductor substrates, flat panel displays, phase change memory devices, solar panels and photovoltaics, and microelectromechanical systems (MEMS).

26. (canceled)

27. (canceled)

28. The method of claim 20, wherein said composition further comprises residue material(s) selected from the group consisting of post-etch residue, post-ash residue, post-CMP residue, and combinations thereof.

29. The method of claim 20, wherein said composition is initially substantially devoid of organic solvents, fluoride species, amine species, abrasive material, compounds having ether bonds, oxidants, organic polymer particles, compounds having a structure in which each of two or more adjacent aliphatic carbons atoms has a hydroxyl group, and combinations thereof.
